(19) United States
(12) Patent Application Publication
(10) Pub. No.: US 2007/0022857 A1
(43) Pub. Date: Feb. 1, 2007

(54) CUTTER DEVICE FOR FLEXIBLE WRAPPING MATERIAL

(76) Inventor: Michael E. Schreiter, Appleton, WI (US)

Correspondence Address: MERCHANT & GOULD PC, P.O. BOX 2903, MINNEAPOLIS, MN, 55402-0903, US

(21) Appl. No.: 11/456,350

(22) Filed: Jul. 10, 2006

Related U.S. Application Data
(60) Provisional application No. 60/700,101, filed on Jul. 18, 2005.

(51) Int. Cl. B26D 5/08

(52) U.S. Cl. 83/614

(57) ABSTRACT

A cutter for flexible wrapping material is structured to be slidably secured around a lip defined along a top edge of a side of the container of the wrapping material. The cutter includes a blade extending inward from one of its inside surfaces. The lip securing the cutter to the box may be made by folding the top edge of the side of the box, or by attaching a separate lip to the top edge.

This application claims priority under 35 U.S.C. § 119(e) to U.S. provisional patent application No. 60/700,101, filed Jul. 18, 2005. The complete disclosure of application No. 60/700,101 is incorporated herein by reference.

### BACKGROUND OF THE INVENTION

1. Field of the Invention

The present invention relates to dispensing and cutting flexible wrapping material. More specifically, the invention provides a cutter for flexible wrapping material that is slidably mounted to the lip of a container of such wrapping material.

2. Description of the Related Art

Numerous devices have been proposed for cutting flexible wrapping material. For example, U.S. Pat. No. 5,398,576, issued to K. W. Chiu on Mar. 21, 1995, disclosing a cutting device having a guide with the configuration of an elongated box having a slot in its top surface. The cutter includes a body having a blade extending downward into the slot, and a pair of guide flanges extending into the slot for securing the cutter thereon. The entire cutting device is mounted on the edge of a box of protective film.

U.S. Pat. No. 5,036,740, issued to C. T. Tsai on Aug. 6, 1991, discloses a cutter apparatus having a guide and a cutter body. The cutter body includes four rollers and a blade extending into a slot on the guide. A base attached to the blade slides within the guide, securing the cutter thereon.

U.S. Pat. No. 3,142,426, issued to C. E. Busse on Jul. 28, 1964, discloses a sliding cutter structured to fit on the cover of a box of aluminum foil or other wrapping material, being retained thereon by the double thickness of the material caused by the flap being folded against the cover. A cutting blade extends downward from the slider, for cutting the aluminum foil or other wrapping material within the box.

U.S. Pat. No. 4,156,382, issued to F. E. Baker on May 29, 1979, discloses a cutter assembly for a home bag sealer. The cutter includes a razor blade secured between a pair of flanges, with a handle secured to the lap of the flanges. The cutter assembly slides along a pair of ribs. The brackets are structured to make it difficult for a person to touch the razor when the cutter is in use. The brackets include a faired surface to guide the plastic bag after cutting.

U.S. Pat. No. 4,787,284, issued to S. H. Chen on Nov. 29, 1988, discloses a cutter mechanism for household plastic wrap. The cutter section includes an I-shaped section securing the cutter within a slot defined within a box, and a top grasping portion. The blade is disposed within a vertical connector between the I-shaped section and the grasping section.

U.S. Pat. No. 5,768,968, issued to Y. H. Park et al., on Jun. 23, 1998, discloses a plastic film wrap dispenser. The dispenser includes a base and a puller structured to frictionally secure the plastic wrap so that pulling the puller away from the base will dispense a desired length of plastic wrap. The puller includes a cutter having a pair of downwardly depending guides structured to secure the cutter within a slot defined within the puller. The cutter further includes a downwardly depending blade. After dispensing a desired length of wrap, the puller may be repositioned on the base, and the cutter may then be moved from one end to the other of the puller to cut the plastic wrap.

U.S. Pat. No. 4,474,318, issued to R. Paren on Oct. 2, 1984, discloses a carton having a serrated edge for tearing plastic wrap, and a lid that cooperates with an exterior wall of the carton to secure the remaining wrapping material in place while the desired length is being cut.

U.S. Pat. No. 4,197,774, issued to B. Singh et al., on Apr. 15, 1980, discloses a cutter assembly. The cutter includes a top member secured to a blade retainer having a shape of an inverted T, structured to retain the cutter within a slot. Either side of the blade retainer includes a blade so that the cutter will cut material when moved in either direction within the slot.

U.S. Pat. No. 5,025,692, issued to D. J. Reynolds on Jun. 25, 1991, discloses a cutter for wall covering sheet rolls. The apparatus includes a container defining a transverse slot in one of its walls to guide a cutter. The cutter may be a simple razor blade. At least one, or possibly a plurality, of longitudinal tracks secure cutters therein for cutting sheet material lengthwise. Each cutter includes a clip member for securing a blade, and a base with a pair of outwardly projecting flanges for engaging a track.

U.S. Pat. No. 5,758,559, issued to M. Capitao on Jun. 2, 1998, discloses a plastic film cutter having a guide with a plurality of inverted U-shaped clamps for clamping to the edge of a carton. Sliding cutters secured within a groove shaped like an inverted T.

U.S. Pat. No. 5,440,961, issued to E. S. Lucas on Aug. 15, 1995, discloses a film cutting apparatus having a guide with a clip for securing the guide to the film material container. A cutter is slidably secured on the guide, with rollers disposed above and below a guide surface of the guide. A cutting wheel is disposed between the upper rollers. The upper rollers include O-rings disposed about their periphery, so that they frictionally engage the material being cut, thereby rotating the rotating cutter. The cutter is moved along the guide to cut the film.

U.S. Patent Application Number US 2004/0089691 A1, filed by K. W. Goralski and published on May 13, 2004, discloses a wrap dispensing box having a cutter bar mounted thereon.

U.S. Pat. No. 5,186,091, issued to M. Wolfe on Feb. 16, 1993, discloses a slitting device that clips to the edge of a sheeting container, and secures a razor blade thereon, for slitting the sheeting to the desired width as sheeting is withdrawn from the container.

U.S. Pat. No. 4,960,022, issued to K. C. Chuang on Oct. 2, 1990, discloses a plastic film cutter. The cutter includes a guide assembly structured to clamp to the film container. The guide assembly includes a channel shaped like an inverted T that contains a lower sliding seat. The lower sliding seat includes an upwardly extending flange that retains a blade therein, and secures to a cutter body. The cutter body includes spring biased rollers for maintaining tension on the plastic film during cutting.

U.S. Pat. No. 6,105,481, issued to P. Schuller on Aug. 22, 2000, discloses a foil dispenser. The dispenser includes a roll chamber for holding a roll of foil, having a dispensing slot defined therein. A holder guide is structured to slidably hold a blade holder therein, with the blade protruding through a slot defined in the holder guide. The blade holder is weighted so that the blade may be moved from side to side, thereby cutting the foil, by tilting the foil dispenser.

U.S. Pat. No. 4,245,536, issued to K. E. Eryan on Jan. 20, 1981, discloses a track for a cutter having a cutting section and a hinged storage section that may be folded against the side of a box, or extended so that the cutter may slide between the cutting section and the storage section.

U.S. Patent Application Number US 2004/0040429 A1, describing an invention by M. S. Mickels et al. and published on Mar. 4, 2004, discloses a sliding cutter assembly having a pair of ends structured to support a roll of material, connected by a guide track. The blade assembly includes a track seating portion fitting within the track, a blade protruding through a slot defined within the track, and a gripping portion on top of the blade.

U.S. Patent Application Number US 2004/0007606, describing an invention by F. E. Baker and published on Jan. 15, 2004, discloses a cutter for cutting sheet material having a handle with an attached cutting blade, and a hook depending downward from the blade. The hook is structured to hook around the flap tucked into the box of sheet material. The cutter handle may further include rollers for engaging the top of the box.

U.S. Patent Application Number US 2004/0194601 A1, describing an invention by C. S. Lin et al., and published on Oct. 7, 2004, discloses a food wrap cutter attached to a container of food wrap. The cutter is structured to guide food wrap across a serrated cutter, and to protect a user's hand from the cutter during dispensing of food wrap.

U.S. Patent Application Number US 2004/0206222 A1, describing an invention by K. C. Chuang, and published on Oct. 21, 2004, discloses a film cutter. The guide for the film cutter is structured to fit on the side of the film dispensing box. The guide includes a channel having the shape of an inverted “T”, structured to retain the slider of a cutter assembly therein. A blade extends upward through the slot, where it is secured to a base outside the guide assembly. The guide assembly further includes a pair of soft plastic film positioning elements substantially parallel to and on either side of the slot.

Many of the above-described devices are complicated and expensive, making them unsuitable for use with a paperboard container that will be discarded when the wrapping material contained therein is used up. Accordingly, there is a need for a cutter for flexible wrapping material that is sufficiently simple and inexpensive to be included as part of a single use container. There is an additional need for a cutter for flexible wrapping material that resists losing the tail of the wrapping material inside the box. There is a further need for a cutter for flexible wrapping material that resists injury to the user of the cutter.

### SUMMARY

This disclosure provides a cutter for flexible wrapping material that meets the above needs. The cutter includes a pair of sides connected by a top, with a blade protruding inward from either one of the two sides or from the top.

In one embodiment, the blade will protrude inward from the outside side of the cutter, to leave a portion of the tail of the wrapping material outside the box.

The bottom edges of the cutter preferably include a pair of inwardly depending flanges structured to fit around a lip defined along the top edge of one of the two sides of the container. The lip may be formed by folding the top edge of the side of the container, or by securing a separate lip to this top edge.

Another guide flange preferably extends longitudinally and outwardly from each side of the cutter, to guide the flexible wrapping material into the cutter as the cutter is slid across the lip.

The cutter may be made from polypropylene, polycarbonate, high density polyethylene, or any other rigid plastic. The blade may be made from metal, such as a razor blade, or the same plastic as the slider portion of the cutter.

A container incorporating a cutter is preferably sufficiently longer than the roll of film contained within the container so that the difference in length is sufficient to contain the cutter, thereby keeping the cutter out of the way when not in use. The container may further include an adhesive strip on the outside of the box, below the lip, to hold the tail of film in place after cutting.

The cutter is preferably structured to be stored underneath the end flap of the container top when the container is not in use, and the end flap is secured to the outside of the side having the lip. The cutter is also structured so that it does not resist tucking the end flap of the lid underneath the side having the cutter secured thereto after the container is first opened.

Accordingly, a cutter for flexible wrapping material that is sufficiently simple and inexpensive for use as part of a single use container is provided.

A cutter for flexible wrapping material that may be made with one-piece construction is provided.

A cutter for flexible wrapping material that may be secured to a lip along the top edge of a side of the container by merely folding the top edge of the container to form the lip is provided.

A container for flexible wrapping material having a slidable cutter disposed thereon is provided.

A container for flexible wrapping material having sufficient length so that a sliding cutter may be stored out of the way of a tail of flexible wrapping material extending out of the container is provided.

A cutter for flexible wrapping material that leaves a portion of the tail of flexible wrapping material outside the container for easy grabbing is provided.

A cutter for flexible wrapping material that resists injury to the user of the cutter is provided.

### BRIEF DESCRIPTION OF THE DRAWINGS

FIG. 1 is an environmental isometric view of one embodiment of a container of flexible wrapping material incorporating a cutter made according to principles of this disclosure;

FIG. 2 is a cutaway side elevational view of one embodiment of a container of flexible wrapping material utilizing a cutter made according to principles of this disclosure;

FIG. 3 is a side elevational view of one embodiment of a cutter according to principles of this disclosure secured to one embodiment of a lip along the top edge of a side of a container;

FIG. 4 is a side elevational view of one embodiment of a cutter according to principles of this disclosure secured to another embodiment of a lip along the top edge of a side of a container;

FIG. 5 is a side elevational view of yet another embodiment of a cutter according to principles of this disclosure secured to yet another embodiment of a lip defined along the top edge of a side of a container;

FIG. 6 is an isometric view of another embodiment of a cutter according to principles of this disclosure;

FIG. 7 is a top plan view of a cutter of FIG. 6; and

FIG. 8 is an end elevational view of a cutter according to FIG. 6.

Like reference characters denote like elements throughout the drawings.

### DETAILED DESCRIPTION OF THE PREFERRED EMBODIMENT

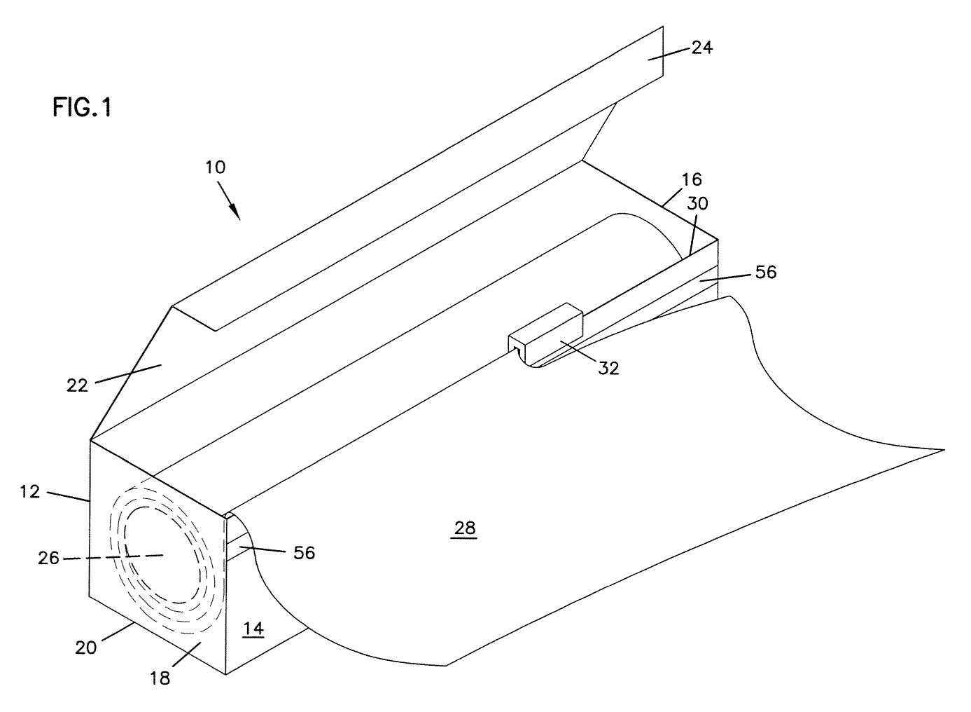

A cutter slidably mounted on a container, such as flexible wrapping material is provided. Referring to FIG. 1, a container 10 incorporating the invention is illustrated. In the embodiment illustrated, the container 10 includes a pair of sides 12, 14, a pair of ends 16, 18, a bottom 20, and a top 22 hingedly secured to the side 12 and preferably including a closure flap 24 disposed along its opposite edge. A core 26 having flexible wrapping material 28 wrapped thereon is contained within the container 10. The side 14 defines an upper edge 30 upon which the cutter 32 is slidably mounted.

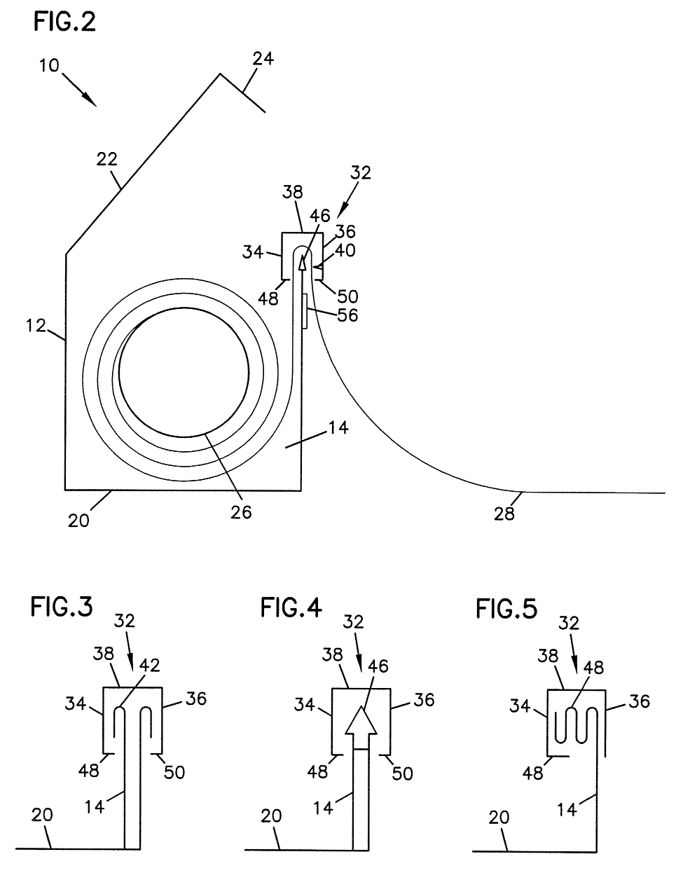

Referring to FIGS. 2-5, the cutter 32 includes a pair of sides 34, 36 connected by a third side or top 38. A blade 40 extends inward from an interior surface of one of the sides 34, 36, or the top 38. In the embodiment shown in FIG. 2, the blade 40 extends inward from the side 36 located outside the container 10, thereby providing a small tail of wrapping material 28 outside the container 10. The blade 40 preferably extends axially along about 10% to about 50% of the side 36 (or side 34 or top 38, depending on where the blade 40 is attached), and extends inward for about 10% to about 40% of the distance between the sides 34, 36. The blade 40 is preferably located at about 20% to about 60% of the distance up from the bottom of the side 34, 36 to which it is secured (or at about 20% to about 80% of the distance from the side 34 if the blade depends downward from the top 38).

In the embodiment of FIG. 3, the upper edge 30 (FIG. 1) of the side 14 defines a lip 42 structured to retain the cutter 32 along the upper edge 30. The lip 42 may be formed by folding the material from which the side 14 is made, as illustrated by the lip 42 in FIG. 3, and the lip 44 in FIG. 5, or by attaching a separate lip 46 to the upper edge 30 as illustrated in FIGS. 2 and 4. The cutter 32 includes a pair of inwardly extending retention flanges 48, 50 extending inward from the bottom of the sides 34, 36 of the cutter 32. The interaction of the retention flanges 48, 50 with the lip 42, 44, 46 resist removal of the cutter 32 from the upper edge 30 of the side 14. If a lip 44 of FIG. 5 is used, only one retention flange 48 is required.

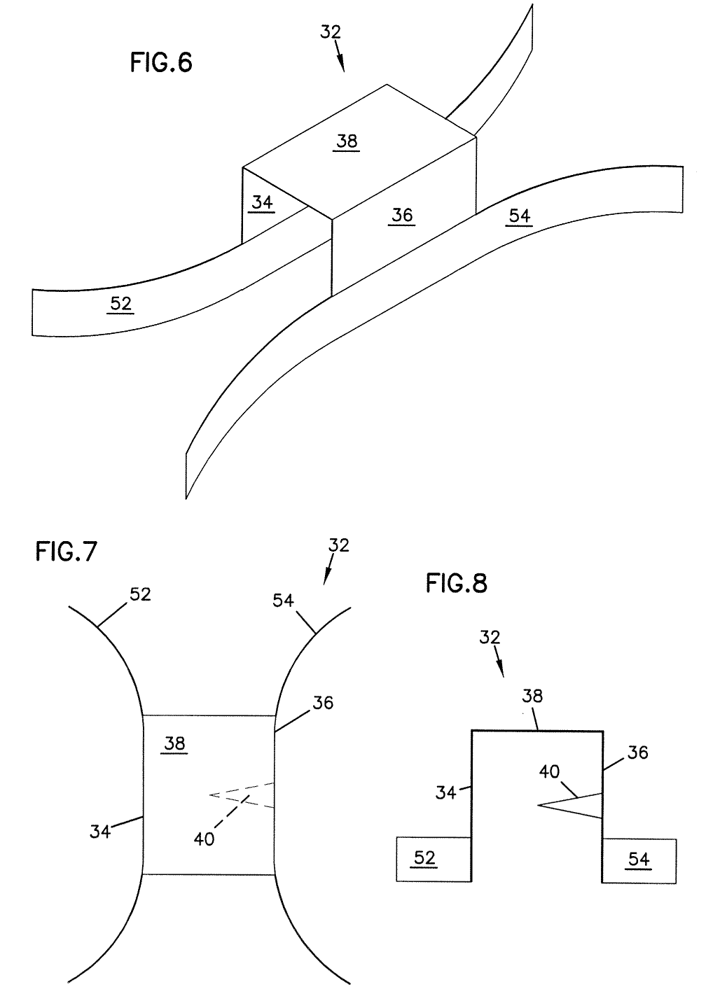

Referring to FIGS. 6-8, the cutter 32 may further include a pair of guide flanges 52, 54, with one guide flange 52, 54 extending longitudinally and outwardly from each of the sides 34, 36. In a preferred embodiment, the guide flanges 52, 54 are disposed at the bottom of the sides 34, 36. The guide flanges 52, 54 are structured to guide flexible wrapping material into the cutter 32 so that it may be cut by the blade 40, regardless of which direction the cutter 32 is moved.

A typical container 10 will be made from paperboard. The cutter 32 is preferably made from polypropylene, polycarbonate, high density polyethylene, or any other rigid plastic. The blade 40 may be made from metal, such as a razor blade, or from the same plastic as the remainder of the cutter 32. If the blade 40 and the remainder of the cutter 32 are made from the same material, those skilled in the art will recognize that an appropriate mold for an injection molder could be made to produce a cutter 32 having one-piece construction.

Referring back to FIGS. 1 and 2, the side 14 of the container 10 may include an adhesive strip 56 secured to its outside surface, below and substantially parallel to the upper edge 30. The adhesive strip 56 permits securing the tail of flexible wrapping material 28 to the adhesive strip 56 to facilitate grabbing the tail of flexible wrapping material 28 for dispensing the appropriate amount of material prior to cutting.

The container 10 is preferably longer than the sum of the length of the core 26 and cutter 32, so that the cutter 32 may be stored out of the way of the flexible wrapping material 28.

When a container 10 of flexible wrapping material 28 is new, the closure flap 24 will typically be secured to the side 14, over the cutter 32, by an adhesive. When a consumer opens the container 10, the consumer will separate the flap 24 from the side 14, open the lid 22, and withdraw a desired length of flexible wrapping material 28. The user may then cut the flexible wrapping material 28 by sliding the cutter 32 from one side of the container 10 to the other, with the flexible wrapping material 28 being guided into the cutter 32 by the guide flanges 52, 54, and cut by the blade 40. The consumer may then adhere the tail of the 5 flexible wrapping material 28 to the adhesive strip 56, and tuck the flap 24 inside the side 14 to close the container 10.

The present invention therefore provides a cutter for flexible wrapping material that is sufficiently simple and inexpensive for use as part of a single use container. Some embodiments of the cutter may be made with one piece construction. The cutter may be secured to the top edge of a side of a container by merely folding the top edge of the container to form a lip. The blade is placed in a location that resists injury to the user of the cutter. Additionally, the cutter facilitates leaving a tail of flexible wrapping material outside the package to facilitate future dispensing of the material.

While specific embodiments of the invention has been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any and all equivalents thereof.

We claim:

1. A cutter for flexible wrapping material, the wrapping material being packaged in a container having a first side, a second side, a pair of ends, and a bottom, the cutter comprising:
a pair of side walls;
a top connecting the pair of side walls;
a blade disposed on an inside surface of one of the pair of sidewalls of the cutter or the top of the cutter; and
the side walls having inwardly projecting flanges disposed at their bottom edges, the inwardly projecting flanges being structured to fit around a lip formed along a top edge of the second side, the cutter thereby being slidably secured to the second side.

2. The cutter according to claim 1, further comprising a pair of guide flanges projecting longitudinally along and outwardly from the side walls of the cutter, the guide flanges being structured to guide wrapping material into the cutter.

3. The cutter according to claim 2, wherein each guide flange has a partially circular configuration.

4. The cutter according to claim 2, wherein each guide flange is disposed at the bottom edge of one of the side walls of the cutter.

5. The cutter according to claim 1, wherein the container further includes a top hingedly secured to the first side and wherein the cutter is structured to fit under the top of the container when the top is sealed to an outside surface of the second side.

6. The cutter according to claim 1, wherein the container further includes a top hingedly secured to the first side and wherein the cutter is structured to fit outside a closure flap of the top of the container when the closure flap is tucked inside the second side of the container.

7. A container for flexible wrapping material, the container comprising:
a first side;
a second side;
a pair of ends;
a bottom;
a top hingedly secured to the first side;
a lip disposed at a top edge of the second side; and
a cutter having;
a pair of side walls;
a top connecting the pair of side walls;
a blade disposed on an inside surface of one of the pair of side walls of the cutter or the top of the cutter; and
the side walls of the cutter having inwardly projecting flanges disposed along their bottom edges, the inwardly projecting flanges being structured to fit around the lip, thereby slidably securing the cutter to the lip.

8. The container according to claim 7, wherein the lip is selected from the group consisting of:
a separate elongated member secured to the top edge of the second side, having a thickness greater than a thickness of the second side; and
a folded portion of the top edge.

9. The container according to claim 7, further comprising a pair of guide flanges projecting longitudinally along and outwardly from the side walls of the cutter, the guide flanges being structured to guide wrapping material into the cutter.

10. The container according to claim 9, wherein each guide flange has a partially circular configuration

11. The container according to claim 9, wherein each guide flange is disposed at the bottom edge of one of the side walls of the cutter.

12. The container according to claim 7, wherein the cutter is structured to fit under the top of the container when the top is sealed to an outside surface of the second side.

13. The container according to claim 7, wherein the cutter is structured to fit outside a closure flap of the top of the container when the closure flap is lucked inside the second side of the container.

14. The container according to claim 7, wherein the container is longer than a sum of a length of a roll of wrapping material stored therein, and a length of the cutter.

15. A method of cutting flexible wrapping material, the wrapping material being packaged in a rigid container having a first side, a second side, a pair of ends, a bottom, and a top hingedly secured to the first side, providing a lip along a top edge of the second side; the method comprising:
providing a cutter having;
a pair of side walls
a top connecting the pair of side walls;
a blade disposed on an inside surface of one of the pair of side walls on the top; and
the side walls having inwardly projecting flanges disposed at their bottom edges, the flanges being structured to fit around the lip, thereby slidably securing the cutter to the lip;
pulling a desired length of wrapping material from the container; and
sliding the cutter along the lip, thereby cutting the wrapping material.
